(19) United States
(12) Patent Application Publication
(10) Pub. No.: US 2021/0207359 A1
(43) Pub. Date: Jul. 8, 2021

(54) MOBILE FACTORY

(71) Applicant: DRECO ENERGY SERVICES ULC, Calgary (CA)

(72) Inventor: Kameron Wayne Konduc, Edmonton (CA)

(21) Appl. No.: 16/993,422

(22) Filed: Aug. 14, 2020

Related U.S. Application Data
(60) Provisional application No. 62/956,796, filed on Jan. 3, 2020.

(51) Int. Cl. E04B 1/343; E04H 5/02; F03D 13/40

(52) U.S. Cl. CPC E04B 1/34357; F03D 13/10; F03D 13/40; E04H 5/02

(57) ABSTRACT

A mobile factory may include a plurality of over-the-road collapsible and expandable modules configured for arrangement adjacent one another to form a fabrication space. The fabrication space may include a welding station, an inspection station, an overhead material handling system, and a rail system.

### CLAIM OF PRIORITY

This patent application claims the benefit of priority of Konduc U.S. Provisional Patent Application Ser. No. 62/956,796, entitled “MOBILE FACTORY,” filed on Jan. 3, 2020 (Attorney Docket No. 5233.153PRV), which is hereby incorporated by reference herein in its entirety.

### TECHNOLOGICAL FIELD

The present disclosure relates to a mobile factory. More particularly, the present disclosure relates to a highway transportable fabrication facility. Still more particularly, the present disclosure relates to a highway transportable fabrication facility particularly adapted for fabricating oversized windmill tower sections.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Land-based windmill towers often include four main components including a foundation, a windmill tower arranged on and extending upward from the foundation, a wind turbine set atop the tower, and a set of turbine blades secured to the turbine. The windmill tower is made up of a series of tower sections that are typically shipped separately to a tower site. A first section may be set on the foundation and the remaining sections may be stacked on top, one after another, to create the tower.

In many land-based windmill farm installations, the various components of the windmill tower may be transported over roads, highways, and/or railroads via truck/trailer combinations, rail cars, or other modes of transportation. Once at the windmill tower farm, the windmill tower components may be assembled, and the windmill tower assembly may be raised to an operating position to provide electricity to an electrical power grid. Higher windmill heights have been shown to produce higher amounts of power, but taller windmills may be limited by shippable component sizes. For example, current tower sections may be limited to a 12 foot diameter to meet highway regulations. An approach to windmill construction that addresses the limitations of over-the-road shipping limitations may allow for taller windmill construction and a better ability to leverage wind power.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one or more embodiments, a mobile factory may include a plurality of over-the-road collapsible and expandable modules configured for arrangement adjacent one another to form a fabrication space. The fabrication space may include a welding station, an inspection station, an overhead material handling system, and a rail system.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is an elevation view of a mobile factory, according to one or more embodiments.

FIG. 2 is an end view of the first module, according to one or more embodiments.

FIG. 3 is side elevation view of a third module for the mobile factory, according to one or more embodiments.

FIG. 4 is an end view of the third module of FIG. 2 in a collapsed configuration, according to one or more embodiments.

FIG. 5 is a side view of the third module of FIG. 3 in a collapsed configuration, according to one or more embodiments.

FIG. 6 is a longitudinal cross-sectional view of the mobile factory, according to one or more embodiments.

FIG. 7 is a closer longitudinal cross-sectional view of the mobile factory, according to one or more embodiments.

FIG. 8A is a longitudinal cross-sectional view of a first zone of the mobile factory, according to one or more embodiments.

FIG. 8B is a longitudinal cross-sectional view of zones, including the first zone, of the mobile factory, according to one or more embodiments.

FIG. 8C is longitudinal cross-sectional view of a third zone of the mobile factory, according to one or more embodiments.

FIG. 9 is an end view of a circumferential welding station, according to one or more embodiments.

FIG. 10 is an end view of a longitudinal welding station, according to one or more embodiments.

FIG. 11 is an end view of an inspection station, according to one or more embodiments.

FIG. 12 is an end view of a cart, according to one or more embodiments.

FIG. 13 is a bottom view of the cart of FIG. 12.

FIG. 14 is a close-up side view of a first portion of the mobile factory, according to one or more embodiments.

FIG. 15 is a close-up side view of another portion of the mobile factory, according to one or more embodiments.

FIG. 16 is a top plan view of a docking area of the mobile factory, according to one or more embodiments.

FIG. 17 is a top plan view of the mobile factory including a tower racking area, according to one or more embodiments.

FIG. 18 is a cross-sectional view of the tower racking area of FIG. 18, according to one or more embodiments.

FIG. 19 is a cross-sectional view of the tower racking area of FIG. 17 showing discharge of a tower section, according to one or more embodiments.

### DETAILED DESCRIPTION

The present disclosure, in one or more embodiments, relates to mobile factory. The mobile factory may include a plurality of modules suitable for over-the-road transportation and collectively may function as a factory when deployed and assembled as a group. The factory may be particularly adapted for plate fabrication including plate forming, welding, cleaning, and finishing. As such, the modules may include particular features adapted to perform these operations and more particularly, for performing these operations to fabricate tower sections for a windmill. The mobile factory may have systems and features for managing differential settlement of the modules, for material handling across and through the modules, for power supply, and for heating and cooling. Still other systems may be included and configured for functioning across a plurality of assembled modules.

The factory may be advantageous for creating tower sections that are twice the diameter of a highway or a railway transportable tower sections. The factory may allow for a climate-controlled grouping of portable buildings that are transported in modules to a. windmill farm where, for example, multiple windmills may be constructed. The factory may be assembled using small cranes to rig up the modules and the entire installation.

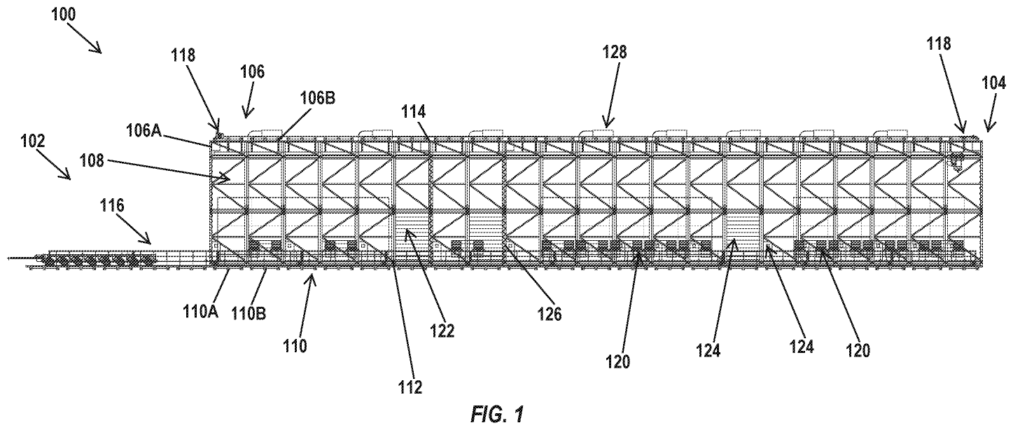

FIG. 1 is an elevation view of a mobile factory 100, according to one or more embodiments. The mobile factory 100 may have a first end 102 and may include a second end 104. The mobile factory 100 may include a plurality of collapsible and expandable modules 106. The modules 106 may be sized and shaped for over-the-road transport (e.g., on a trailer, rail car, or the like). The modules 106 may be arranged adjacent one another, for example to form a fabrication space 108. In an example, the plurality of modules 106 may include a first module 106A and a second module 106B. The first module 106A may be arranged adjacent the second module 106B, for example to provide a portion of the fabrication space 108.

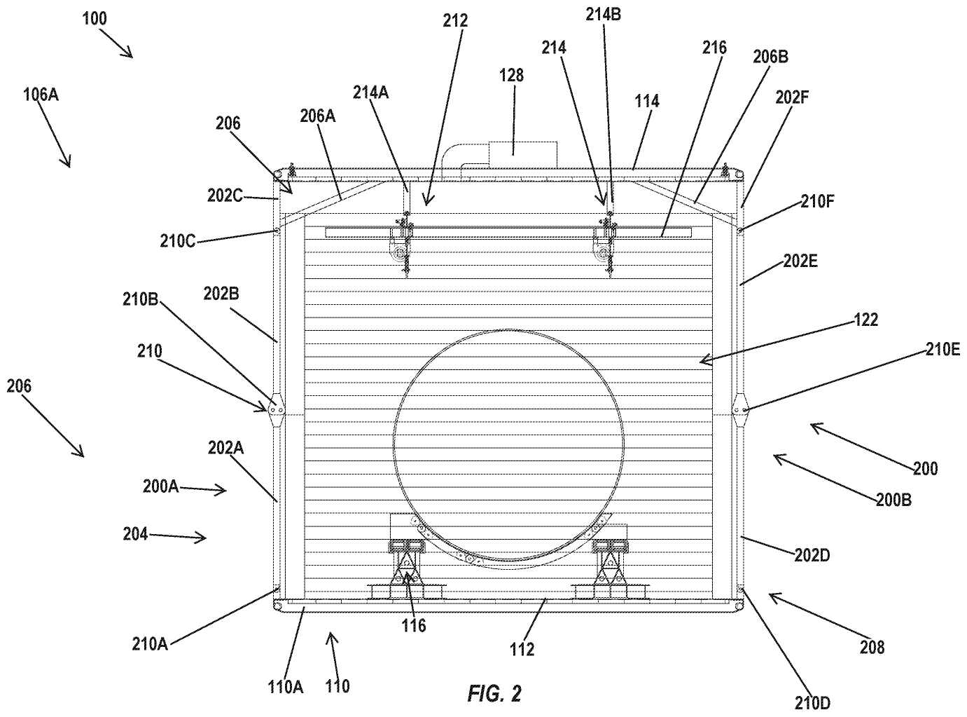

FIG. 2 is an end view of the first module 106A, according to one or more embodiments. FIG. 2 shows the module 106A in an expanded configuration. The mobile factory 100 may include one or more skids 110. For example, the skids 110 may be included in the plurality of modules 106. The first module 106A may include a first skid 110A second skid 110B may be included in the second module 106B. The skids 110 may include the floor 112 (or a portion of the floor 112). The floor 112 may be included in the fabrication space 108. The fabrication space 108 of the mobile factory 100 may be located between the floor 112 and a roof 114 of the mobile factory 100.

The modules 106 (e.g., the first module 106A, or the like) may include one or more walls 200. For instance, the walls 200 may be coupled to the skids 110 of the modules 106. The walls 200 may include one or more wall sections 202. In an example, a first wall section 202A may be coupled to the skid 110A. A second wall section 202B may be coupled to the first wall section 202A. A third wall section 202C may be coupled to the second wall section 202B. The walls 200 may be coupled to the roof 114 of the modules 106. For instance, the third wall section 202C may be coupled to the roof 114 of the first module 106A. The wall sections 202A, 202B, 202C may be included on a first side 204 of the mobile factory 100. For instance, the wall sections 202A, 202B, 202C may cooperate to provide a first wail 200A (or a portion of the first wall 200A) for the mobile factory 100. The modules 106 may include one or more cross members 206. For instance, a first cross member 206A may extend between the roof 114 and the third wall section 202C.

In an example, the modules 106 include the walls 200 on one or more sides (e.g., the first side 208) of the modules 106. For instance, the first wall 200A may be located on the first side 200A of the module 110A. The module 110A may include a second wall 200B, for instance on a second side 208 of the mobile factory 100. The second wall 200B may include a fourth wall section 202D. The wall section 202D may be coupled to the skid 110 (e.g., on the second side 208 of the skid 110). A fifth wall section 202E may be coupled to the fourth wall section 202D. A sixth wall section 202F may be coupled to the fifth wall section 202E. The sixth wall section 202F may be coupled to the roof 114 of the module 110A. A second cross member 206B may extend between the roof 114 and the wall section 202. Accordingly, the wall sections 202D, 202E, 202F may cooperate to provide the second wall 200B.

As described herein, the modules 106 are collapsible and expandable. For example, the walls 200 may include one or more joints 210. The joints 210 may facilitate relative movement between components of the modules 106. For instance, the joints 210 may be located between sections 202 of the walls 200, or between other components of the modules 106. In an example, the first wall section 202A may be coupled with the first skid 110A at a first joint 210A. The second wall section 202B may be coupled with the first wall section 202A at a second joint 210B. The third wall section 202C may be coupled to the second wall section 202C at a third joint 210C. The fourth wall section 202D may be coupled to the skid 110B at a fourth joint 210D. The fifth wall section 202E may be coupled to the fourth wall section 202D at a fifth joint 210E. The sixth wall section 202F may be coupled to the fifth wall section 202E at a sixth joint 210F. Accordingly, sections 202 of the walls 200 may move relative to each other, for instance to facilitate collapsing and expanding of the walls 200 (or other components of the mobile factory 100).

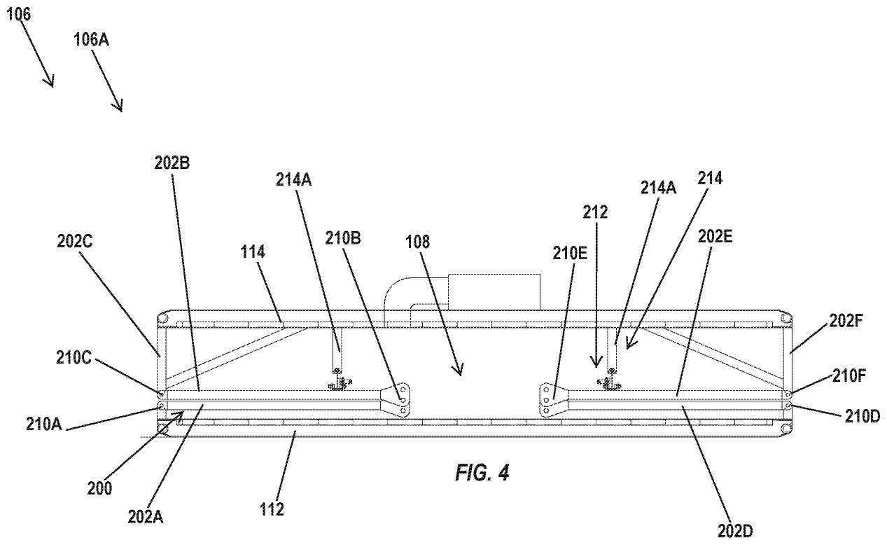

The modules 106 may include an expanded configuration (e.g., as shown in FIG. 2) and a collapsed configuration (e.g., as shown in FIG. 4). In the expanded configuration, the joints 210 may be aligned. For example, the joint 210B may be vertically aligned with the joints 210A, 210C. The joint 210E may be vertically aligned with the joints 210D, 210F. The joint 210A may be remote from the joint 210C. The joint 210D may be the joint 210F.

The wall sections 202 may be aligned with the modules in the expanded configuration. For instance, the wall section 202A may be vertically aligned with the wall section 202B. The wall section 202A may be vertically aligned with the wall section 202C. The wall section 202B may be vertically aligned with the wall section 202C. The wall section 202D may be vertically aligned with the wall section 202E. The wall section 202D may be vertically aligned with the wall section 202F. The wall section 202E may be vertically aligned with the wall section 202F. Accordingly, one or more of the wall sections 202 or the joints 210 may be aligned in the expanded configuration.

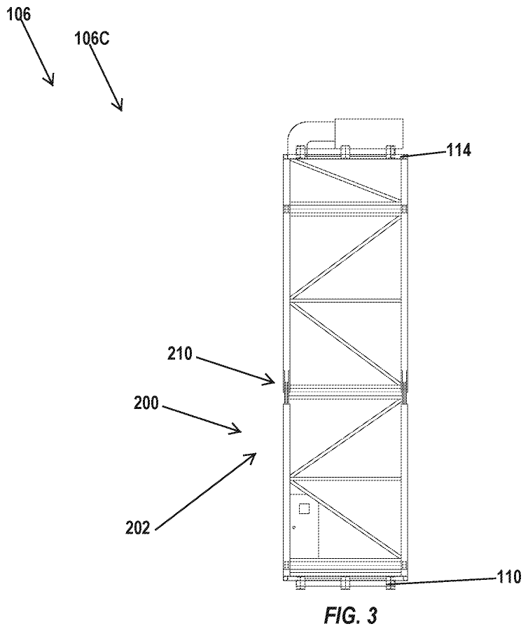

FIG. 3 is side elevation view of a third module 106C for the mobile factory 100, according to one or more embodiments. FIG. 3 shows the module 106C in an expanded configuration. As described herein, the modules 106 (e.g., the module 106C) may include the walls 200. In an example, the wall sections 202 may be coupled between the skid 110 and the roof 114 of the module 106C. The joints 210 may facilitate coupling the wall sections 202 with each other (e.g., the wall sections 202A and 202B, shown in FIG. 2). The joints 210 may facilitate coupling the wall sections 202 with other components of the mobile factory 100, for instance the skid 110 and the roof 114.

FIG. 4 is an end view of the module 106A of FIG. 2 in a collapsed configuration, according to one or more embodiments. As described herein, the joints 210 may facilitate relative motion between components of the modules 106. For example, in the collapsed configuration, the wall section 202A may be aligned with floor 112 of the module 106A. The wall section 202B may be aligned with the floor 112 of the module 106A. The wall section 202B may be aligned with the wall section 202A. The wall sections 202A, 202B may extend into the fabrication space 108. The joint 210B may be horizontally displaced relative to the joints 210A, 210C. For instance, the joint 210B may be out of vertical alignment with the joints 210A, 210C. The joint 210B may be located in the fabrication space 108. In an example, the wall sections 202A, 202B may extend inward with respect to the wall section 202C. The joint 210A may be proximate the joint 210C. The joint 210D may be proximate the joint 210F.

In an example with the module 106A in the collapsed configuration, the wall section 202D may be aligned with floor 112 of the module 106A (e.g., in a horizontal orientation, or the like). The wall section 202E may be aligned with the floor 112 of the module 106A. The wall section 202E may be aligned with the wall section 202D. The wall sections 202D, 202E may extend into the fabrication space 108. The joint 210E may be horizontally displaced relative to the joints 210D, 210F. For instance, the joint 210E may be out of vertical alignment with the joints 210F, 210F. The joint 210E may be located in the fabrication space 108. In an example, the wall sections 202D, 202E may extend inward with respect to the wall section 202F.

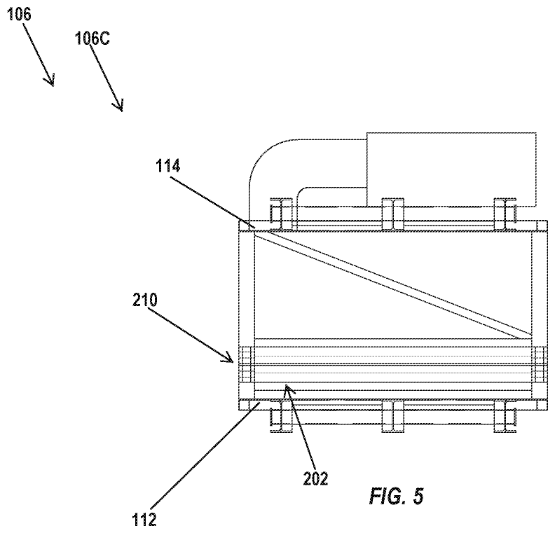

FIG. 5 is a side view of the module 106C of FIG. 3 in a collapsed configuration, according to one or more embodiments. The wall sections 202 and the joints 210 may cooperate to facilitate transitioning the modules 106 between the expanded configuration and the collapsed configuration. For example, in the collapsed configuration, a vertical height (e.g., a distance between the floor 112 and the roof 114) of the module 106C may be reduced in comparison to the vertical height of the module 106C in the expanded configuration (e.g., as shown in FIG. 3).

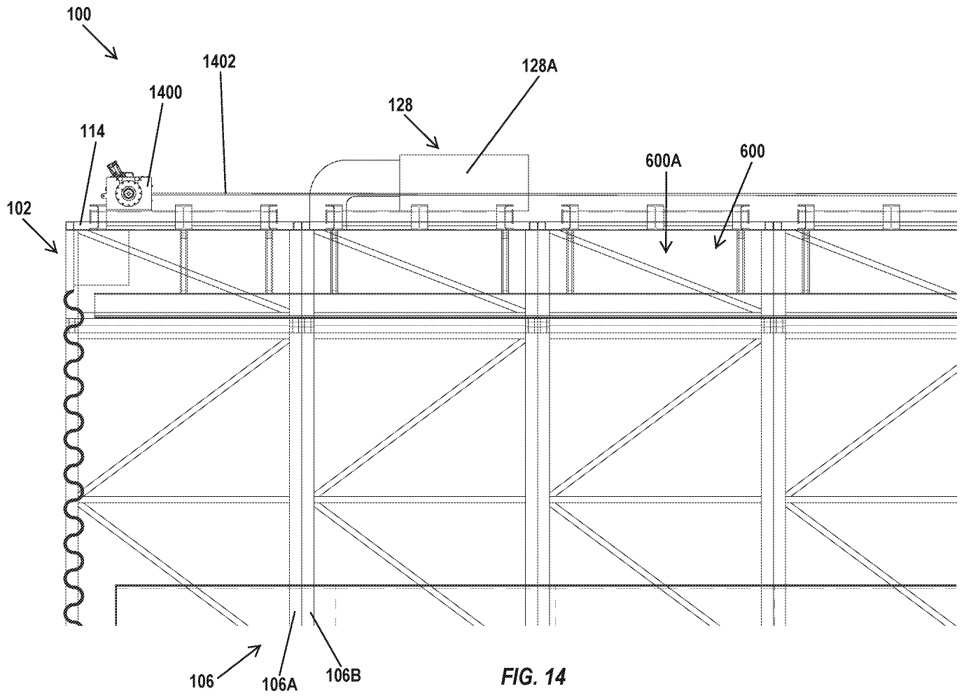

The mobile factory 100 may include a tensioning system 118, for instance extending across the modules 106. The tensioning system 118 may help provide rigidity and sealing between each module 106. In an example, the tensioning system 118 extends across the roof 114 of the mobile factory 100. The tensioning system 118 may include a tension member 1402 (e.g., a cable, cord, rope, or the like). The tension member 1402 may be coupled with the drive unit 1400. The tension member 1402 may extend from the drive unit 1400. The tension member 1402 may extend across one or more of the skids 110. For example, the tension member 1402 may extend across the roof 114 of the mobile factory 100. The tension member 1402 may extend along the skids 110 at the first end 102 of the mobile factory 100. The tension member 1402 may extend toward the second end 104 of the mobile factory 100 (shown in FIG. 14B).

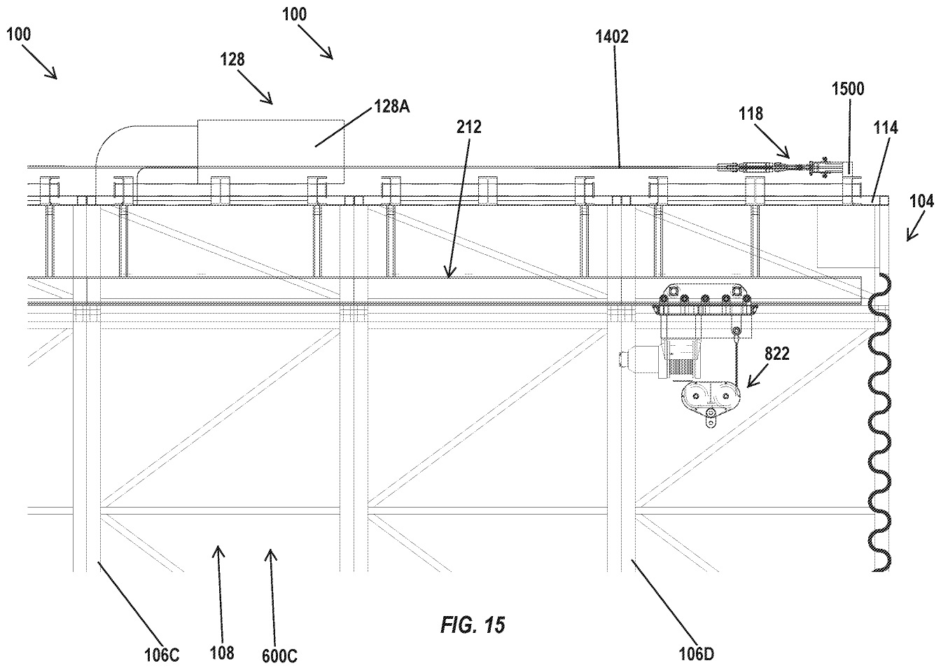

FIG. 15 is a close-up side view of another portion of the mobile factory 100, according to one or more embodiments. The tensioning system 118 may include the tension member 1402. The tensioning system 118 may include an anchor point 1500. For instance, the anchor point 1500 may be coupled with the roof 114 of the mobile factory 100. In an example, the anchor point 1500 is included in a fourth module 106D of the mobile factory. The tension member 1402 may extend between the tensioning drive unit 1400 (shown in FIG. 14) and the anchor point 1500. Accordingly, the tension member 1402 may extend across the modules 106, for example from the first module 106A at the first end 102 of the mobile factory 100 (shown in FIG. 14) to the fourth module 106D at the second end 104 of the mobile factory 100. The tension member 1402 may extend across an exterior of the mobile factory 100 (e.g., along a top of the roof 114, or the like). The tension member 1402 may extend within an interior of the mobile factory 100 (e.g., within the fabrication space 108, or the like).

FIG. 14 is a close-up side view of a first portion of the mobile factory 100, according to one or more embodiments. The tensioning system 118 may include a tensioning drive unit 1400. The drive unit 1400 may include a motor, gearbox, or the like. The drive unit 1400 may be coupled with the first module 106A. For instance, the drive unit 1400 may be located proximate the first end 102 of the mobile factory 100.

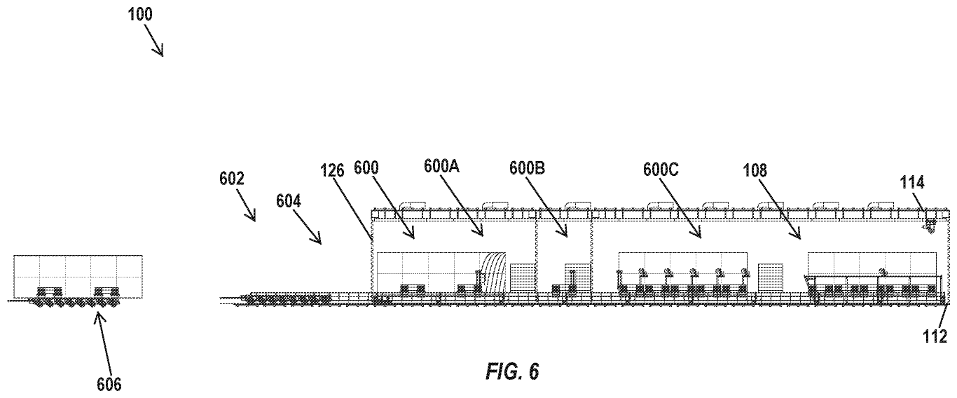

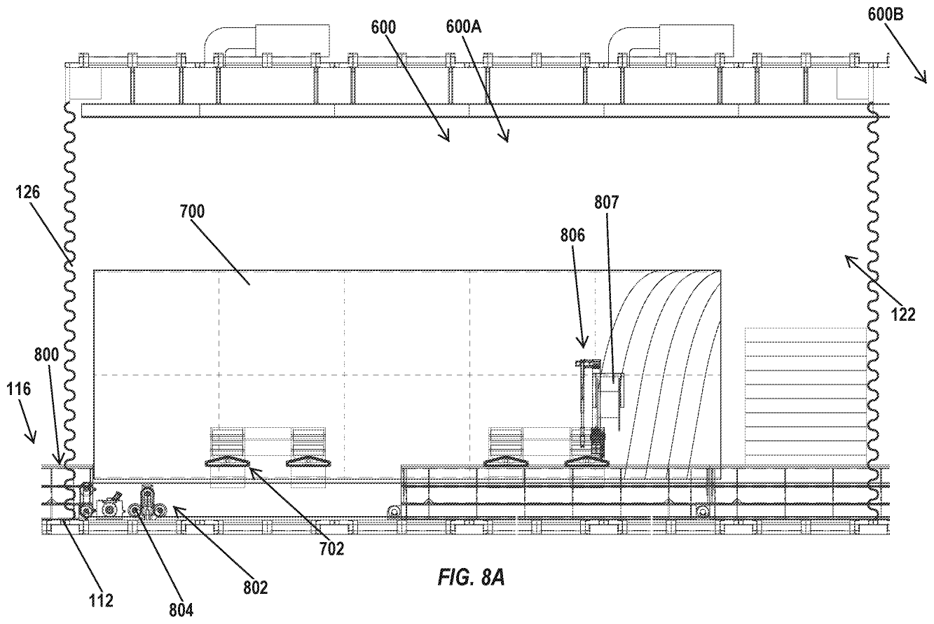

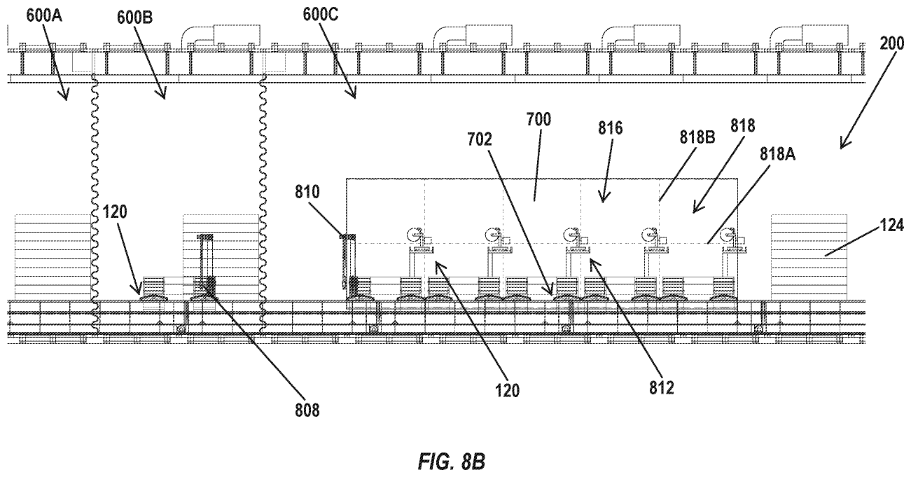

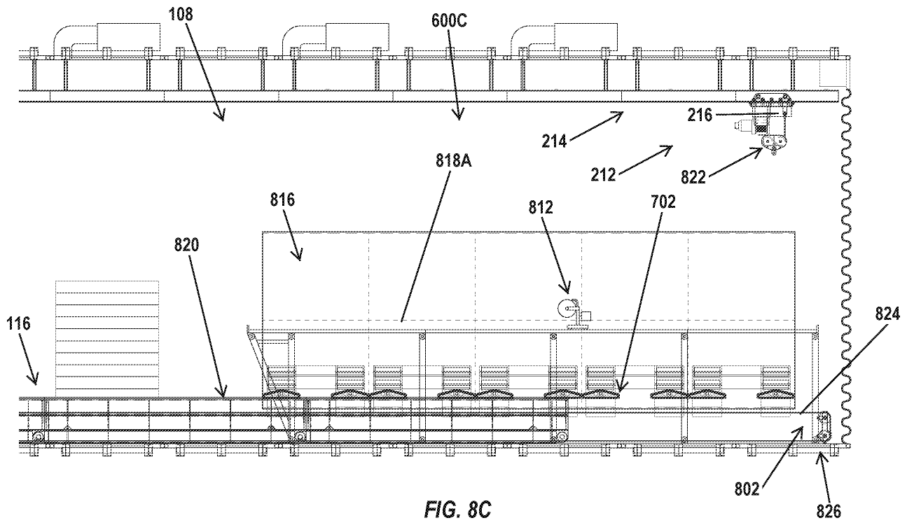

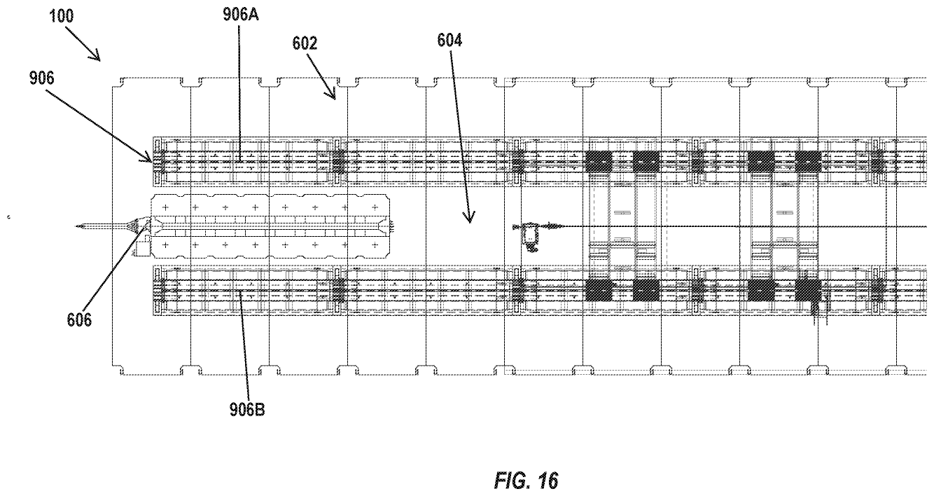

The mobile factory 100 may include one or more zones 600 (shown in FIG. 6). For example, the one or more zones 600 may include the fabrication space 108. For example, fabrication space 108 may include a first zone 600A (shown in FIG. 8A). The fabrication space 108 may include a second zone 600B. The fabrication space 108 may include a third zone 600C. An exterior 602 of the mobile factory 100 may be included in the zones 600 of the mobile factory 100. In an example, the mobile factory 100 includes a docking area 604, for instance located in the exterior 602 of the mobile factory 100. The docking area 604 may receive a trailer 606, or the like. For instance, the docking area 604 may be located between the rails 906 of the continuous rail system 116 (shown in FIG. 16). In an example, the docking area 604 may receive the trailer 606 between the rail 906A and the rail 906B.

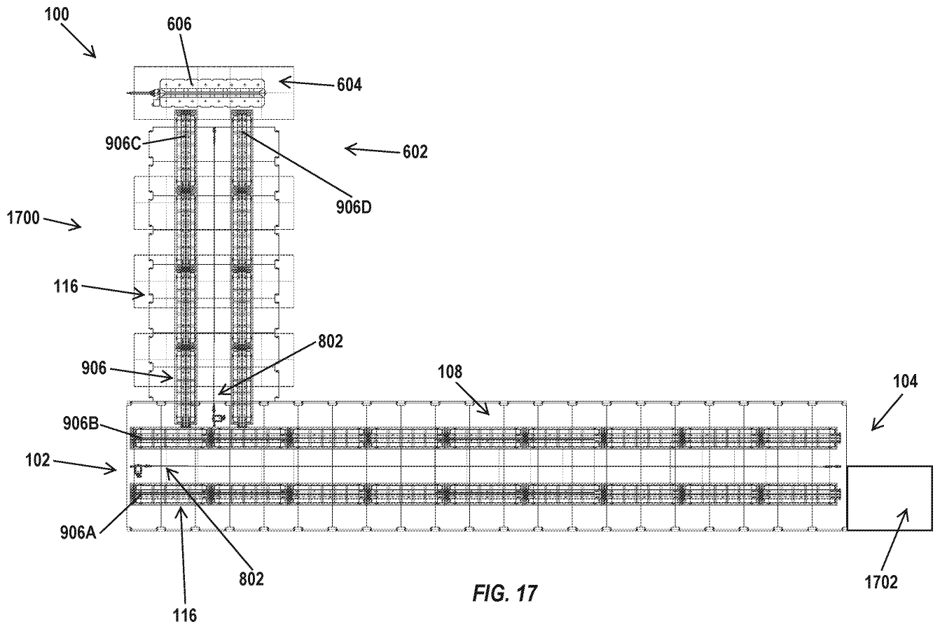

FIG. 17 is a top plan view of a mobile factory having a tower racking area 1700, according to one or more embodiments. The tower racking area 1700 may facilitate storage of tower sections 700. In an example, the tower sections 700 may include one or more sub-sections 816 (shown in FIG. 8B). The sub-sections 816 may include a rolled sheet (e.g., a curved piece of sheet metal, or the like). The sub-sections 816 may be coupled to each other, for example to provide the tower sections 700.

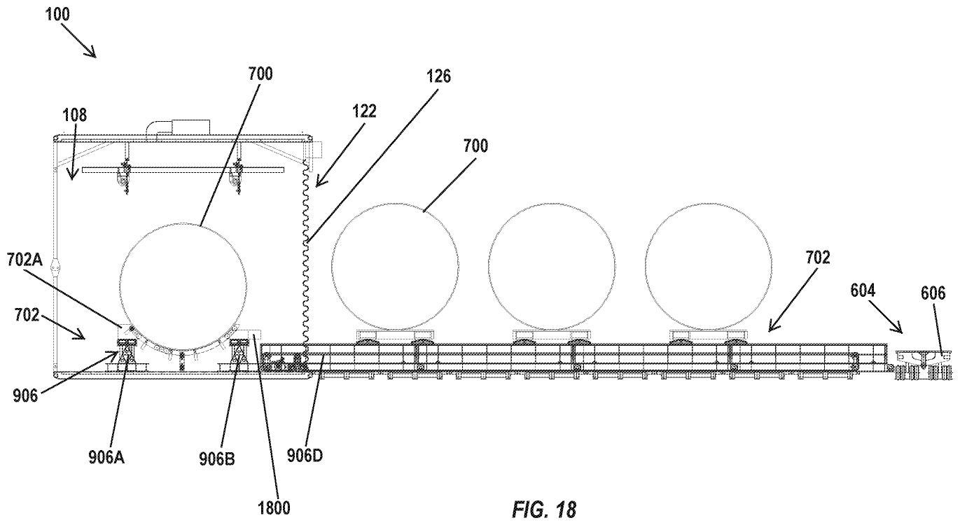

FIG. 18 is a cross-sectional view of the tower racking area 1700 of FIG. 17, according to one or more embodiments. The tower racking area 170 may be included in the zones 600 of the mobile factory 100. The tower racking area 1700 may be arranged alongside the fabrication space 108. The tower racking area 1700 may include the docking area 604. The tower racking area 1700 may include the continuous rail system 116.

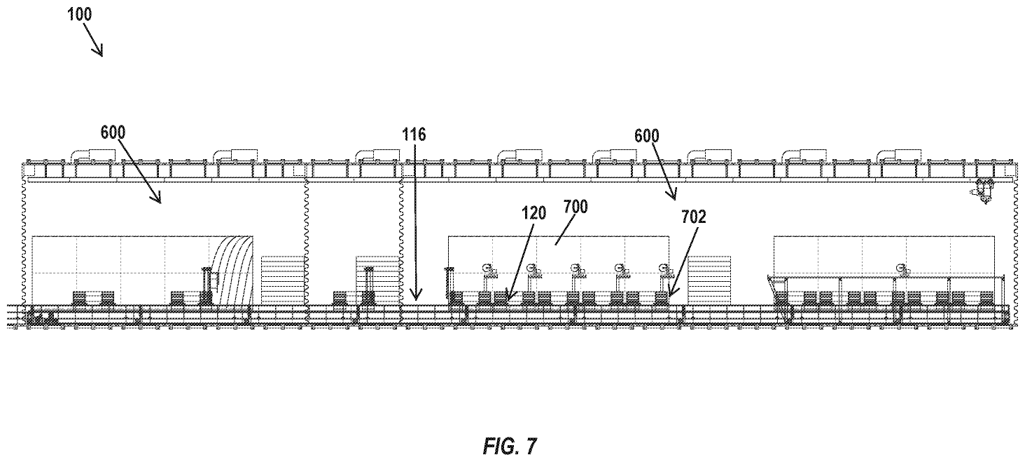

Referring again to FIG. 1, the mobile factory 100 may include a continuous rail system 116, for instance located in the fabrication space 108. The continuous rail system 116 may extend through the mobile factory 100. For example, the continuous rail system 116 may extend across the plurality of modules 106. The continuous rail system 116 may extend from the first end 102 to the second end 104 of the mobile factory 100 (however, the present subject matter is not so limited). For example, the continuous rail system 116 may extend through the zones 600 of the mobile factory. In an example, the continuous rail system 116 may extend through the zones 600A, 600B, 600C of the fabrication space 108 (shown in FIG. 7). The continuous rail system 116 may extend to the exterior 602 of the mobile factory 100, for instance extending to the docking area 604 of the mobile factory 100. The continuous rail system 116 may extend from the exterior 602 of the mobile factory 100 into the fabrication space 108. For example, the continuous rail system 116 may extend through the curtains 126.

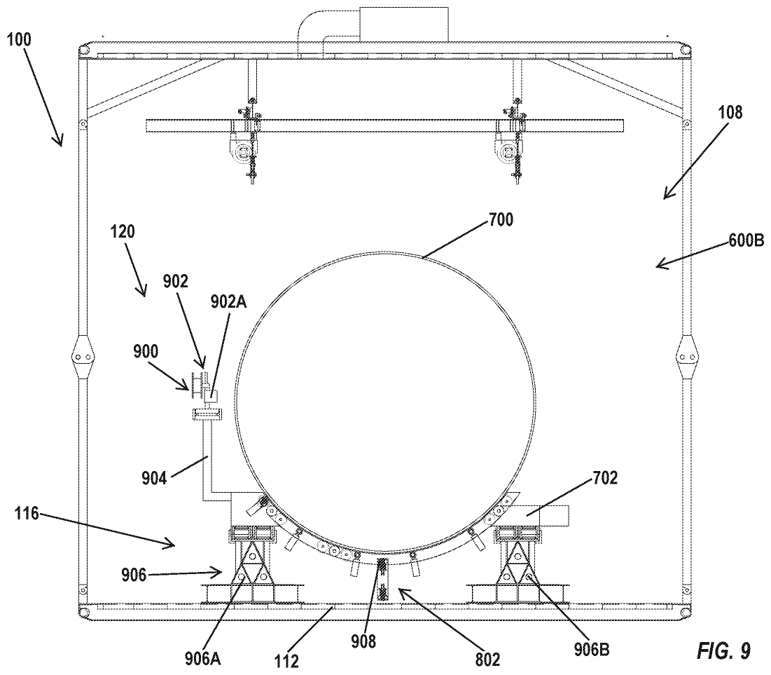

The continuous rail system 116 may be coupled to the floor 112 of the first module 106A. For instance, the continuous rail system 116 may include one or more rails 906 (shown in FIG. 9). The one or more rails 906 may be coupled to the floor 112 of the mobile factory 100. In an example, the rails 906 may include a first rail 906A and a second rail 906B. The rails 906 may be pinned to the floor 112 of the building. The rails 906 may extend through mobile factory 100, for instance extending through the fabrication space 108 of the mobile factory 100. The rails 906A, 906B may extend between the ends 102, 104 of the mobile factory 100. The rail 906A may be spaced apart from the rail 906B. The rail 906A may be parallel with the second rail 906B (however, the present subject matter is not so limited).

The one or more rails 906 (and the continuous rail system 116) may be the same or similar to the rails described in U.S. patent application Ser. No. 15/498,572, entitled Guide Rails for Mobile Drilling Rig, and filed on Apr. 27, 2017, the content of which is hereby incorporated by reference here in its entirety. In an example, the rail 906A may include one or more segments, and the segments of the rail 906A may be connected together, for instance with a moment resisting connection. The moment resisting connection may transfer a load experienced by one segment of the rail 906A to adjacent segments of the rail 906A. Accordingly, the moment resisting connection of the segments of the rail 906A mitigate deformation, beam deflection, shearing, or sinking of the segments of the rails 906.

The moment resisting connection of the segments of the rails 906 facilitates alignment of the modules 106. For instance, the rail system 116 may enhance the rigidity of the mobile factory 100. In an example, the continuous rail system 116 extends across the modules 106 (and the joints between the modules 106). The continuous rail system 116 may be coupled to the floor 112 of the modules 106. The moment resisting connection between segments of the rails 906 may facilitate alignment of the modules 106 because the continuous rail system 116 is coupled with the modules 106, and the rail system 116 includes moment resisting connections between the segments of the rails 906. The moment resisting connections between the segments of the rails 906 enhances the rigidity of the modules 106, for example by reducing differential settling (e.g., vertical misalignment, horizontal misalignment, torsion, or the like) of modules 106. For instance, the continuous rail system 116 may mitigate deformation, beam deflection, shearing, or sinking of the modules 106 (e.g., when a tower section 700 is moved through the fabrication space 118). Accordingly, the continuous rail system 116 enhances the rigidity of the mobile factory 100 and reduces misalignment between modules 106 (or other components of the mobile factory 100).

In an example, the tower racking area 1700 may include the rails 906 of the continuous rail system 116. For instance, the racking area 1700 may include a third rail 906C and a fourth rail 906D. The rails 906C, 906D may extend at an angle with respect to the rails 906A, 906B. For example, the rails 905C, 905D may be perpendicular to the rails 906A, 906B. The rails 906C, 906D may extend from within the fabrication space 108 to the exterior 602 of the mobile factory 100. The rails 906C, 906D may be arranged proximate to the rails 906A, 906B, for instance to facilitate transferring tower sections 700 between the fabrication space 108 and the tower racking area 1700. The rails 906C, 906D may extend between the fabrication space 108 and the docking area 604.

In an example, the mobile factory 100 may include one or more carts 702. The carts 702 may support the tower sections 700, for example during a manufacturing operation with the manufacturing stations 120. The carts 702 may be moveably coupled to the continuous rail system 116. In an example, the continuous rail system 116 may include a. cart support surface 820. The carts 702 may move (e.g., roll, slide, translate, glide, or the like) along the cart support surface 820. Accordingly, the carts 702 may move along the continuous rail system 116, for instance to transition between zones 600 of the mobile factory 100. In an example, the tower sections 700 may move along the continuous rail system 116, for example when the carts 702 support the tower sections 700 and the carts 702 move along the continuous rail system 116.

In an example, one or more portions of the cart 702 may extend below the cart support surface 820 of the rails 906 (also shown, for example, in FIG. 8C). For instance, the cart 702 may include a cradle 1106. The cradle 1106 may span between the rails 906 of the continuous rail system 116 (shown in FIG. 9). The cradle 1106 may extend below the cart support surface 820. The cradle 1106 may receive the tower section 700 (or a portion of the tower section). For instance, the cradle 1106 may support the tower section 700 (or the sub-sections 816). Accordingly, a portion of the tower section 700 may be located below the support surface 820.

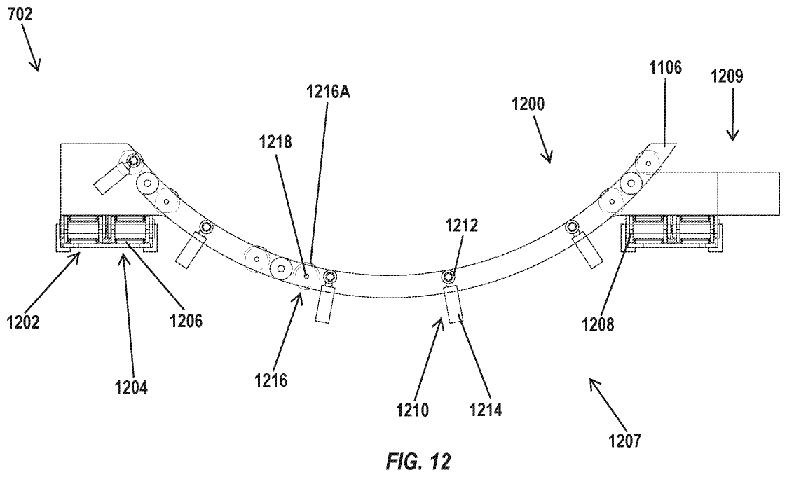

FIG. 12 is an end view of the cart 702, according to one or more embodiments. A cradle recess 1200 of the cradle 1106 may receive the tower sections 700. In an example, the tower sections 700 may rest within the cradle recess 1200. The cradle 1106 may include a semicircular profile. For example, the semicircular profile of the cradle 1106 may correspond to a circular profile of the tower sections 700 (e.g., an inner diameter of the cradle 1106 may correspond to an outer profile of the tower sections 700).

The cart 702 may include one or more feet 1202. The feet 1202 may facilitate movement of the cart 702 relative to the continuous rail system 116 (shown in FIG. 1). In an example, the feet 1202 may include at least one continuous track assembly 1204. For instance, the track assembly 1204 may include a track 1206. The track 1206 may move, for instance according to movement of the cart 702 along the continuous rail system 116. The track 1206 may be driven, for instance to move the track 1206 relative to a track assembly housing 1208. The track assembly housing 1208 may be coupled to the cradle 1106. The track 1206 (e.g., a rubber track, or the like) may engage with the cart support surface 820 of the continuous rail system 116 (shown in FIG. 8C). For example, the track 1206 may roll along the cart support surface 820. The feet 1202 may include one or more wheels, bearings or the like that engage with the cart support surface 820 (e.g., to facilitate movement of the cart 702 along the rails 906, shown in FIG. 9). The track assembly 1204 may be located on a first side 1207 (e.g., bottom side, or the like) of the cart 702. The cradle recess 1200 may be located on a second side 1209 (e.g., a top side, or the like) of the cart 702.

The cart 702 may include a first track assembly 1204A, for instance located on a first end 1300 of the cart 702. The cart 702 may include a second track assembly 1204B, for example located on a second end 1302 of the cart 702. In an example, the track assembly 1204A may be located proximate a first corner of the cart 702. The track assembly 1204B may be located proximate a second corner of the cart 702. A third track assembly 1204C may be located proximate a third corner of the cart 702. The cart 702 may include a fourth track assembly 1204C located proximate a fourth corner of the cart 702. The track assemblies 1204 may be aligned with each other. For instance, the track assembly 1204A may be aligned with the track assembly 1204C. The track assembly 1204B may be aligned with the track assembly 1204D. For instance, the track assemblies 1204A, 1204C may be moveably coupled with the first rail 906A (shown in FIG. 9). The track assemblies 1204B, 1204D may be moveably coupled with the second rail 906B (shown in FIG. 9).

The cart 702 may include an adjustment cylinder 1210. The adjustment cylinder 1210 may include a piston 1212 and a cylinder housing 1214. In an example, the cylinder housing 1214 may be coupled to the cradle 1106. The piston 1212 may move relative to the cylinder housing 1214. The piston 1212 may extend from the cradle 1106. The piston 1212 may extend into the cradle recess 1200.

The cart 702 may include one or more rollers 1216. For instance, the one or more rollers 1216 may be rotatably coupled with the cradle 1106. In an example, the cart 702 may include a first roller 1216A. The cart 702 may include an axle 1218, for instance to facilitate rotation of the roller 1216A relative to the cradle 1106. The rollers 1216 may extend into the cradle recess 1200.

The carts 702 may include a transition lip 1800. For instance, a first cart 702A may include the transition lip 1800. The first cart 702A may be moveably coupled with the rails 906A, 906B. The transition lip 1800 of the cart 702A may extend toward the rail 906D (and the rail 906C, shown in FIG. 17). The transition lip 1800 may provide a transition between the rails 906A, 906B and the rails 906C, 906D.

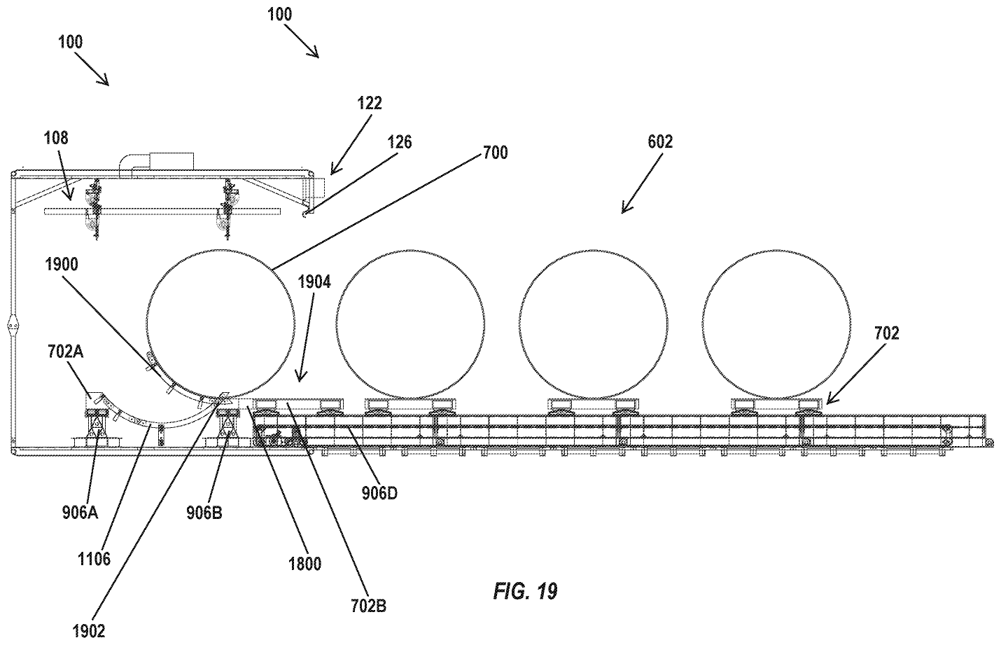

FIG. 19 is a cross-sectional view of the tower racking area 1700 of FIG. 17 showing discharge of a tower section, such as one or more of the tower sections 700, according to one or more embodiments. As described herein, the cart 702A may include the transition lip 1800, and the cart 702A may be moveably coupled with the rails 906A, 906B. A second cart 702B may be moveably coupled with the rail 906C (shown in FIG. 17) and the rail 906D. The second cart 702B may be located proximate to the first cart 702A. For example, the cart 702B may abut against the transition lip 1800 of the cart 702A.

The carts 702, for instance the first cart 702A, may include a transition arm 1900. In an example, the cradle 1106 includes the transition arm 1900. The transition arm 1900 may rotate with respect to the cart 702A. For instance, the transition arm 1900 may move the tower section 700, for example to transfer the tower section 700 to the cart 702B from the cart 702A.

The mobile factory 100 may include a transportation system 802 (shown in FIGS. 8A-8C). The transportation system 802 may facilitate movement of the carts 702 relative to the continuous rail system 116. In an example, the transportation system 802 may be located between the cart 702 and the floor 112 of the mobile factory 100. The cart 702 (e.g., the cradle 1106, or the like) may receive a portion of the transportation system 802, for instance the transportation tension member 824. The cart 702 may include a clutch 908 (shown in FIG. 9). The clutch 908 may be included in the cradle 1106. The clutch 908 may selectively engage with the transportation tension member 824, for instance to move the cart 702 along the continuous rail system 116. In some examples, the cart 702 may engage with the transportation system 802 at a location below the support surface 820. For instance, the cradle 1106 of the cart 702 may engage with the transportation system 802.

The transportation system 802 may include a drive unit 804 (shown in FIG. 8A). The drive unit 804 may be located proximate to the continuous rail system 116. In an example, the drive unit 804 may be coupled to the floor 112 of the mobile factory 100, for instance coupled to the floor adjacent the continuous rail system 116. The drive unit 804 may include one or more of a pully, gear box, transmission, motor, engine, or the like.

The transportation system 802 may be aligned with the continuous rail system 116. For instance, one or more components of the transportation system 802 may be located between the one or more rails 906. In an example, the transportation tension member 824 (shown in FIG. 8C) may be located between the rails 906A and the rail 906B. The transportation system 802 may be located between the rail 906C and the rail 906D. The transportation system 802 may extend along the rails 906.

The transportation system 802 may extend between through the fabrication space 108. The transportation system 802 may extend between the fabrication space 108 and the docking area 604. For example, the transportation tension member 824 may extend through the fabrication space 108. The transportation tension member 824 may be engaged with one or more pullies 826. The transportation tension member 824 may extend between pullies 826 and the drive unit 804 (shown in FIG. 8A). The tension member 824 may be located below the cart support surface 820. The tension member 824 may extend parallel to one or more of the rails 906A, 906B, 906C, 906D.

The mobile factory 100 may include a suspended rail system 212. In an example, the suspended rail system 212 may be coupled to the roof 114 of the modules 106. For instance, one or more suspended rails 214 may be coupled to the roof 114. A first suspended. rail 214A may be coupled to the roof 114. A second suspended rail 214B may be coupled to the roof 114. The suspended rails 214 may extend parallel to the continuous rail system 116. The suspended rails 214 may be located above the continuous rail system 116. The suspended rail system 212 may span across one or more of the modules 106. In an example, the suspended rail system 212 may be coupled to the roof 114 of the modules 106. The suspended rail system 212 may span between the ends 102, 104 of the mobile factory 100, for example spanning between the module 106A (shown in FIG. 14) and the module 106D.

In some examples, a cross rail 216 may be included in the suspended rail system 212. For example, the cross rail 216 may extend between the suspended rails 214 (e.g., the suspended rails 214A, 214B). For instance, the suspended rails 214 may extend in a first direction (e.g., between the ends 102, 104 of the mobile factory 100, shown in FIG. 1), and the cross rail 216 may extend in a second direction (e.g., perpendicular to the first direction, for instance between the sides 204, 208 of the mobile factory 100). The cross rail 216 may be moveably coupled with the rails 214A, 214B.

The suspended rail system 212 may be contained in modules 106 with the modules in the collapsed configuration. For instance, the wall sections 202 may accommodate the suspended rails 214. In an example, the suspended rail 214A may be located between the wall section 202B and the roof 114. The suspended rail 214B may be located between the wall section 202E and the roof 114.

The mobile factory 100 may include an overhead component handling system 822 (e.g., a crane, pulley, block and tackle, or the like). The overhead component handling system 822 may be moveably coupled with the suspended rail system 212. For instance, the overhead component handling system 822 may be moveably coupled with the rails 214 or the cross rail 216. The overhead component handling system 822 may move within the fabrication space 108.

One or more fabrications stations 120 may be included in the mobile factory 100. For instance, the fabrication stations 120 may be located in the zones 600 of the mobile factory 100 (e.g., in the fabrication space 108, or the like). The fabrication stations 120 may facilitate one or more manufacturing operations, for example manufacturing of one or more tower sections 700. In an example, the mobile factory 100 may include a plate preparation station 1702 (shown in FIG. 17). The plate preparation station 1702 may include the fabrication stations 120. The plate preparation station 1702 may be located in the exterior 602 of the mobile factory 100. For instance, the plate preparation area 1702 may be located at the second end 104 of the mobile factory 100.

FIG. 8C is longitudinal cross-sectional view of the third zone 600C of the mobile factory 100, according to one or more embodiments. The fabrication stations 120 may include one or more welding stations 812. The welding stations 812 may be included in the zones 600 of the mobile factory 100. For instance, the third zone 600C may include the welding stations 812. The welding stations 812 may be coupled with the floor 112. The welding stations 812 may be coupled with the carts 702.

The welding stations 812 may facilitate manufacturing of the tower sections 700. For instance, the tower sections 700 may include one or more sub-sections 816. The sub-sections 816 may include a rolled sheet (e.g., a curved piece of sheet metal, or the like). The sub-sections 816 may be coupled to each other, for example to provide the tower sections 700. In an example, the sub-sections 816 may be welded along one or more seams 818. For example, the tower sections 700 may include a longitudinal seam 818A. The tower sections 700 may include a circumferential seam 818B. The sub-sections 816 may be welded along the seams 818 to provide the tower sections 700. In an example, the sub-sections 816 are welded along the longitudinal seam 818A, for instance in the third zone 600C (shown in FIG. 8C) of the mobile factory 100. The sub-sections 816 may be welded along the circumferential seam 818B, for example in the second zone 600B (shown in FIG. 8B) of the mobile factory 100.

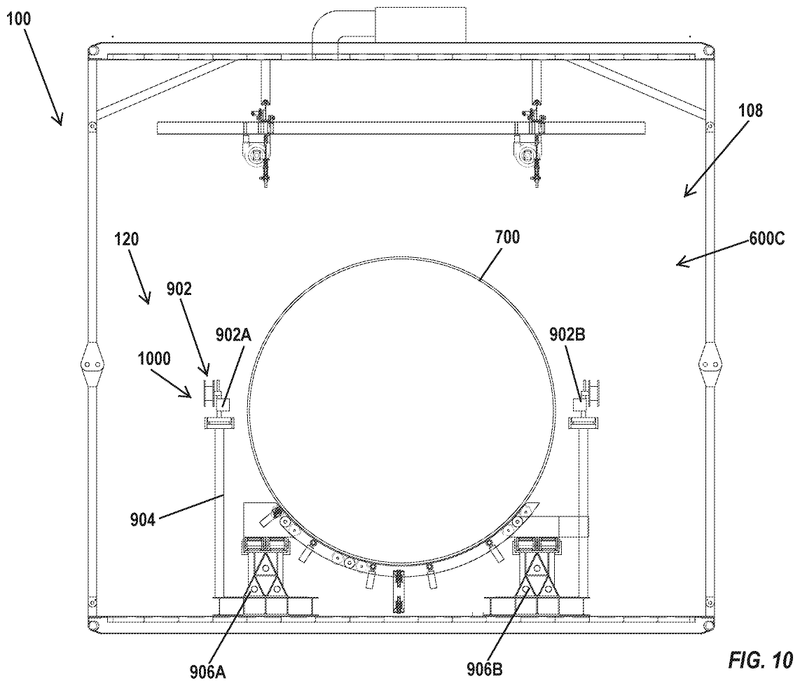

FIG. 10 is an end view of a longitudinal welding station 1000, according to one or more embodiments. In an example, the longitudinal welding station 1000 is located in the fabrication space 108, for example in the third zone 600C of the mobile factory 100. The longitudinal welding station 1000 may include the one or more welding heads 902, for example the first welding head 902A and a second welding head 902B. In an example, the first welding head 902 is located proximate the first rail 906A. The first welding head 90A2 may be located on a first side of the tower section 700. The second welding head 1004 may be located proximate the second rail 906B. The second welding head 1004 may located on a second side of the tower section 700.

The welding heads 902 may be stationary. For instance, the welding head 902A (or the welding head 902B) may be coupled to the floor 112 (or the continuous rail system 116), for example with the wielding support arm 904. The welding support arm 904 may be coupled to the cart 702. The welding head 902B may be coupled to the welding support arm 904. The cart 702 may support the tower section 700. The welding heads 902 may be located proximate the tower section 700, for instance when the cart 702 supports the tower section 700.

FIG. 9 is an end view of a circumferential welding station 900, according to one or more embodiments. The fabrication stations 120 may include the circumferential welding station 900. In an example, the circumferential welding station 900 is located in the fabrication space 108, for example in the second zone 600B of the mobile factory 100. The circumferential welding station 900 may include one or more welding heads 902, for instance a first welding head 902A. The welding head 902 may be stationary. For instance, the welding head 902A may be coupled to the cart 702, for example with a wielding support arm 904. The welding support arm 904 may be coupled to the cart 702. The welding head 902A may be coupled to the welding support arm 904. The cart 702 may support the tower section 700. The welding head 902A may be located proximate the tower section 700, for instance when the cart 702 supports the tower section 700.

The mobile factory 100 may include an inspection station 810. For instance, the inspection station 810 may be included in the fabrication stations 120. The inspection station 810 may include one or more of x-ray imaging, ultrasonic imaging, microscopic imaging, or the like. The inspection station 810 may facilitate quality control of the tower sections 700. In an example, the inspection station 810 may be located in the third zone 600C of the mobile factory 100. The inspection station 810 may be coupled with the floor 112. The inspection station 810 may be coupled with the cart 702. The inspection station 810 may be coupled with the continuous rail system 116.

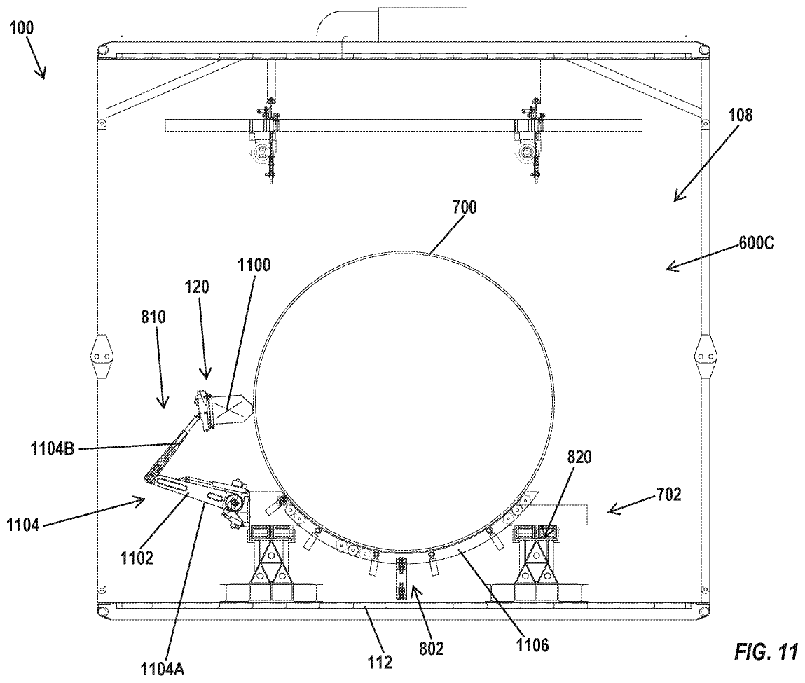

FIG. 11 is an end view of the inspection station 810, according to one or more embodiments. In an example, the inspection station 810 may be located in the fabrication space 108, for example in the second zone 600B of the mobile factory 100. The inspection station 810 may include one or more inspection instruments 1100. The inspection instruments 1100 may include (but are not limited to) one or more of x-ray imaging, ultrasonic imaging, microscopic imaging, or the like.

The mobile factory 100 may include a robotic arm 1102. In an example, the robotic arm 1102 may include one or more arm segments 1104. For instance, the robotic arm 1102 may include a first arm segment 1104A and a second arm segment 1104B. The arm segments 1104 may move relative to each other, for example to articulate the inspection instruments relative to the tower sections 700. The robotic arm 1102 may be coupled to the cart 702. The robotic arm 1102 may be coupled to the continuous rail system 116. The robotic arm 1102 may be coupled to other components of the mobile factory 100, for instance the floor 112 of the mobile factory 100. The robotic arm 1102 may include the welding heads 902. The robotic arm 1102 may include the inspection instruments 1100.

FIG. 8B is a longitudinal cross-sectional view of the zones 600A, 600B, 600C of the mobile factory 100, according to one or more embodiments. In an example, the fabrication stations 120 may include a cleaning station 808. The cleaning station 808 may facilitate cleaning of the tower sections 700. In an example, the cleaning station 808 may be located in the second zone 600B of the mobile factory 100. The cleaning station 808 may be coupled with the floor 112. The cleaning station 808 may be coupled with the cart 702. The cleaning station 808 may be coupled with the continuous rail system 116.

The fabrication stations 120 may include a finishing station 806 (shown in FIG. 8A). For instance, the finishing station 806 may apply a coating (e.g., paint, enamel, vinyl, plastic, or the like) to the tower sections 700. In an example, a vinyl wrapper 807 may couple a vinyl material (e.g., a sheet of vinyl, plastic, or the like) to the tower sections 700. The finishing station 806 may be coupled with the floor 112. The finishing station 806 may be coupled with the cart 702. The finishing station 806 may be coupled with the continuous rail system 116.

Referring again to FIG. 1, the mobile factory 100 may include one or more access systems 122. The access systems 122 may divide the zones 600 of the mobile factory 100. The access systems 122 may be included in the modules 106. For example, the first module 106A may include the access systems 122. The access systems 122 may be located between the fabrication space 108 and the tower racking area 1700. The access systems 122 may be located between the fabrication space 108 and the exterior 602 of the mobile factory 100.

In an example, the access systems 122 may include one or more doors 124 (e.g., roller doors, garage doors, people doors, or the like). The doors 124 may provide access to the mobile factory 100 (e.g., access to the fabrication space 108 from the exterior 602 of the mobile factory 100, shown in FIG. 6). The doors 124 may provide access to other areas of the mobile factory 100 (e.g., offices, storage, or the like). The doors 124 may be included in the walls 200 of the mobile factory 100.

The access systems 122 may include one or more curtains 126 (e.g., strips of plastic or rubber, partitions, or the like). The access systems 122 may be located in the fabrication space 108. For instance, the curtains 126 may be located between the exterior 602 and the fabrication space 108 of the mobile factory 100. The curtains 126 may extend between the floor 112 and the roof 114 of the mobile factory 100. The curtains 126 may extend between the floor 112 and the roof 114 of the fabrication space 108. FIG. 18 shows the curtain in a lowered configuration. FIG. 19 shows the curtain 126 in a raised configuration. In an example, the tower section 700 may transition between the fabrication space 108 and the exterior 602 of the mobile factory 100 when the curtain 126 is in the raised configuration.

In some examples, the mobile factory 100 includes one or more heating, ventilating, or air conditioning (“HVAC”) systems 128. The HVAC systems 128 may be included in the zones 600 of the mobile factory 100. For instance, the HVAC systems 128 may be located on the roof 114 of the mobile factory 100. In an example, the first module 106A may include the HVAC systems 128, for instance located on the roof 114 of the first module 106A. A first HVAC system 128A (e.g., an air handler, or the like) may be coupled with the second module 600B. The first HVAC system 128A may condition the first zone 600A of the mobile factory 100. A second HVAC system 128B may be included in the third module 106C of the mobile factory 100. The second HVAC system 128B may condition the third zone 600C of the mobile factory 100.

The present disclosure, in one or more embodiments, relates to a mobile factory, for instance the mobile factory 100 (shown in FIG. 1). The factory 100 may allow for a climate-controlled grouping of portable buildings that are transported in modules to a windmill farm where, for example, multiple windmills may be constructed. The factory 100 may be assembled, for example using small cranes to rig up the modules 106 and the entire installation.

The mobile factory 100 may include the plurality of modules 106, which may be suitable for over-the-road transportation and collectively may function as a factory when deployed and assembled as a group. The factory 100 may be particularly adapted for plate fabrication including plate forming, welding, cleaning, and finishing. As such, the modules 106 may include particular features adapted to perform these operations and more particularly, for performing these operations to fabricate the tower sections 700. In an example, the tower sections 700 are components of a windmill.

The factory 100 may be advantageous for creating tower sections 700 that are twice the diameter of a highway or a railway transportable tower sections. In an example, the mobile factory 100 may manufacture a 60 foot long tower section 700, however the present subject matter is not so limited. Thus, the mobile factory 100 may manufacture tower sections 700 that exceed over-the-road restrictions. For instance, dimensions of the tower sections 700 may exceed the regulated dimensions of objects that are allowed to be transported on a public roadway.

The mobile factory 100 may have systems and features for managing differential settlement of the modules (e.g., with the skids 110, shown in FIG. 1), for material handling across and through the modules (e.g., the continuous rail system 116), for power supply, and for heating and cooling (e.g., the HCAC systems 128). Still other systems may be included and configured for functioning across a plurality of the assembled modules 106. The mobile factory 100 may be powered with a generator for remote locations, but may also be powered with highline power, or green power such as a solar array and a battery bank, for example.

As shown in FIG. 1, the factory 100 may include several collapsible and expandable building modules, for instance the modules 106. The modules 106 may be designed to work on very soft ground, for example with a bearing capacity of less than 2000 pounds per square foot providing for a wide range of factory locations. With a system of the skids 110 and the rails 906, a muddy soft earth foundation may be adequate to support the anticipated portable factory loads, and the windmill tower sections. Referring again to FIGS. 3 and 4, the mobile factory 100 may include the modules 106 and the skids 110. The walls 200 may be coupled with the skids 110. For instance, walls 200 may include the joints 210, and the joints 210 may facilitate relative movement between components of the modules 106.

In an example, the wall section 202A may pivot relative to the wall section 202B at the joint 210B. The wall sections 202 may pivot relative to the floor 112. The wall sections 202 may pivot relative to the skids 110. The wall sections 202 may pivot relative to the roof 114. Accordingly, the relative movement between components of the modules 106 may facilitate transitioning (e.g., folding, condensing, consolidating, collapsing, unfolding, expanding, opening, deploying, or the like) the modules 106 between an expanded configuration (shown in FIG. 3) and a collapsed configuration (shown in FIG. 4). For instance, the walls 200 may transition to the collapsed configuration to facilitate transportation of the modules 106 (e.g., loading onto bed trucks, lifted with small rubber tire cranes, or the like). The modules 106 (including the floor 112 and the roof 114) may be assembled together, or disassembled. For instance, the roof 114 may be attached to the walls 200. In another example, the wall sections 202C, 202F may be unfolded with respect to the roof 114, (e.g., into an upside-down “U” arrangement) and attached to the wall sections 202B, 202E.

Components of the modules 106 (e.g., the skids 110, floor 112, roof 114, wall sections 202, or the like) may be assembled together. For instance, the wall sections 202 may be attached to the skids 110. The sections 202 may be locked together with each other (e.g., the wall section 202A may be locked together with the wall section 202B), for example with ISO 1161 shipping container locks or links and lugs. The sections 202 may be locked together with the floor 112. The sections 202 may be locked together with the roof 114. Locking the sections 202 (or unlocking the sections 202) may transition the modules 106 between the expanded configuration and the collapsed configuration.

The components, equipment, or the like for the mobile factory 100 may be housed inside of this building cross section. The mobile factory 100 may include the suspended rail system 212, lights, utilities, or the like attached to the underside of the roof 114. The components of the mobile factory 100 (e.g., the continuous rail system 116, access systems 122, suspended rail system 212, or the like) may be protected while being transported by the wall sections 202 that are folded in the collapsed configuration (e.g., to surround, encase, stow, or the like the components of the mobile factory 100).

As discussed herein, the modules 106 may be assembled, for instance to provide the mobile factory 100. In one or more embodiments, a 50 foot long skid 110 with the walls 200 may provide for a module (e.g., module 106A) that is 50 feet long by 50 feet high by 12 to 14 feet wide. The plurality of modules 106 may be tied together, for example to make the mobile factory over 200 feet long. A bottom of these modules 106 may be sheeted in, for instance to provide mats. In an example, the modules 106 may be squeezed (e.g., drawn, pulled, pushed, compressed, or the like) together, for example using the tensioning system 118 (e.g., as shown, for example, in FIGS. 14-15). The tensioning system 118 may help provide rigidity and sealing between each module 106 (e.g., between the module 106A and the module 106B, shown in FIG. 14). For instance, the drive unit 1400 may apply a force to the tension member 1402. In an example, the drive unit 1400 may pull on the tension member 1402. The tension member 1402 may extend between the drive unit 1400 and the anchor point 1500. The application of force to the tension member 1402 may squeeze the modules 106 together. For example, the second module 106B (shown in FIG. 14) and the third module 106C (shown in FIG. 15) may be squeezed between the first module 106A (shown in FIG. 14) and the fourth module 106D. In another example, the modules 106 are secured together, for instance with one or more fasteners, welds, seals, epoxies, or the like.

The sub-sections 816 and the tower sections 700 may be moved within the mobile factory 100. In an example, the sub-sections 816 may be presented to the continuous rail system 116, for example by loading from a 90 degree angle from the main track, by either the carts 702 or a roller track assembly. In an example, the sub-sections 816 may be loaded onto one or more of the carts 702 on the continuous rail system 116 of the factory 100. For instance, the mobile factory 100 may facilitate movement of the tower sections 700 within the fabrication space 108. The tower sections 700 may be moved along the continuous rail system 116 between the fabrication stations 120. The tower sections 700 may be moved along the continuous rail system 116 between the zones 600 of the mobile factory 100.

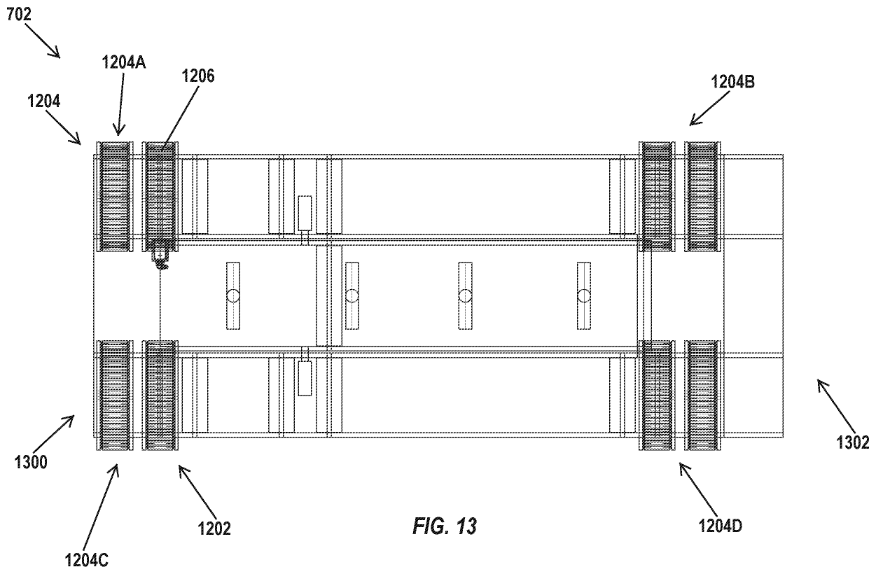

The cart support surface 820 of the rails 906 may support the carts 702, and the carts 702 may transport the partially completed windmill tower as it goes through the one or more manufacturing operations. For example, the track 1206 (e.g., a rubber track, or the like) may engage with the cart support surface 820 of the continuous rail system 116 (shown in FIG. 8C). Referring again to FIGS. 11-13, the cart 702 may include the continuous track assembly 1204 and the track 1206. The track 1206 may move, for instance according to movement of the cart 702 along the continuous rail system 116. For example, the track 1206 may roll along the cart support surface 820, for instance when the clutch 908 of the cart 702 is engaged with the tension member 824 driven by the drive unit 804 for the transportation system 802.

Referring again to FIGS. 8A and 8C, the mobile factory 100 may include the transportation system 802. The transportation system 802 may facilitate movement of the carts 702 relative to the continuous rail system 116 (or within the mobile factory 100). For example, the transportation system 802 may include the drive unit 804. The transportation tension member 824 may extend between the pullies 826 and the drive unit 804. The drive unit 804 may drive the tension member 824, for example to rotate the tension member 824 about the pullies 826. In an example, the tension member 824 may rotate at a specified rate through the fabrication space 108. The clutch 908 (shown in FIG. 9) of the cart 702 may selectively engage with the tension member 824. The engagement between the clutch 908 and the tension member 824 may move (e.g., tow, pull, drive, drag, or the like) the cart 702 along the continuous rail system 116.

The carts 702 (or the overhead component handling system 822) may facilitate movement of the tower sections 700 along one or more degrees of freedom. For example, the tower sections 700 may have a circular profile, and the carts 702 may facilitate rotation of the tower section 700 about a rotational axis of the tower section 700. The mobile factory 100 may facilitate movement of the tower section 700 along a longitudinal axis (e.g., by moving the tower section 700 along the rails 906). For example, the mobile factory 100 may facilitate movement of the tower sections 700 between fabrication stations 1210 within the fabrication space 108. The carts 702 may displace the tower section, for example to adjust a position of the tower section 700 (or the sub-sections 816).

In an example, the carts 702 may facilitate rotation of the tower sections 700 about a rotational axis. The cart 702 may include one or more rollers 1216 (shown in FIG. 12). For instance, the one or more rollers 1216 may be rotatably coupled with the cradle 1106. The cradle recess 1200 of the cradle 1106 may support the tower section 700. The rollers 1216 may extend into the cradle recess 1200. The rollers 1216 may engage with the tower section 700, for example when the tower section 700 is supported in the cradle recess 1200. In an example, rotation of the rollers 1216 may correspondingly rotate the tower sections 700. For instance, the tower sections 700 may rotate within the cradle recess 1200.

As described herein, the carts 702 may include the rollers 1216, and the rollers 1216 may move (e.g., rotate) the tower section 700 received in the cradle recess 1200. The carts 702 may include the adjustment cylinders 1210, and the adjustment cylinders 1210 may move (e.g., translate, manipulate, adjust, displace, lift, push, pull, skew, tilt, tweak, or the like) the tower section 700. In an example, the adjustment cylinders 1210 may help provide a tapered profile to the tower section 700 (or the sub-sections 816) during manufacturing of the tower section 700. Accordingly, the adjustment cylinders 1210 facilitate manufacturing of the tower sections 700 because the location of the tower sections 700 may be altered during manufacturing (e.g., to fine tune the location of the sub-sections 816 prior to welding of the sub-sections 816). In an example, the piston 1212 may move relative to the cylinder housing 1214 for instance extending into (or retracting from) the cradle recess 1200. The piston 1212 may engage with the tower section 700, for example to move the tower section 700 relative to the cart 702 (e.g., within the cradle recess 1200).

In some examples, the mobile factory 100 may include the overhead component handling system 822 (e.g., a crane, pulley, block and tackle, or the like). The overhead component handling system 822 may be moveably coupled with the suspended rail system 212. For instance, the overhead component handling system 822 may be moveably coupled with the rails 214 or the cross rail 216 (shown in FIG. 2). Accordingly, the handling system 100 may move throughout the fabrication space, for instance to facilitate movement of components of the windmill (e.g., the sub-sections 816, tower sections 700, internal windmill components, or the like).

The tower section 700 may be moved along the continuous rail system 116, for example to an inspection station 810 (shown in FIG. 8). The carts 702 (and the continuous rail system 116) may facilitate evaluation of the tower sections 700. For example, the carts 702 may rotate the tower sections 700 relative to the inspection station 810. The carts 702 may move the tower sections laterally relative to the inspection station 810. Accordingly, the inspection station 810 may be stationary, and the carts 702 may facilitate inspection of the tower sections 700 with the stationary inspection station 810. After evaluation, the tower section 700 may be moved, for example along the continuous rail system 116 to the cleaning station 808 (shown in FIG. 8B). The tower section 700 may be moved (e.g., along the continuous rail system 116) to the finishing station 806. The factory 100 may also expel the completed tower sections 700 at the end 102 of the factory 100 in a straight longitudinal line (e.g., the sub-sections 816 of the tower sections 700 are fabricated at the end 104, and completed tower sections 700 are expelled at the end 102).

Referring again to FIGS. 17-19, the tower section 700 may be moved from the fabrication space 108, for example after corrosion control operations are conducted on the tower sections 700. In an example, tower sections 700 may be transferred to the tower racking area 1700 from the fabrication space 108. For instance, the tower section 700 may be transferred between the continuous rail system 116 of the fabrication space 108 to the continuous rail system 116 of the tower racking area 1700. For instance, the tower section 700 may be transferred from the first cart 702A to the second cart 702B (shown in FIG. 19). The transition arm 1900 of the cart 702A may rotate with respect to the cart 702A. The transition arm 1900 may move the tower section 700, for example to transfer the tower section 700 to the cart 702B from the cart 702A. In an example, the transition arm 1900 may roll the tower section 700 from the cart 702A to the cart 702B. For instance, the cart 702B may abut against the transition lip 1800 of the cart 702A. Accordingly, the tower section 700 may roll from the cradle 1106 (e.g., due to movement of the transition arm 1900, or the like) to a racking surface 1904 of the cart 702B. Thus, the tower section 700 may be transferred between carts 702 and the zones 600 of the mobile factory. The cart 702A of the fabrication space 108 may stay within the fabrication space 108, and the cart 702B of the tower racking area 1700 may stay within the tower racking area 1700.

Inside the modules 106, the rigidity (e.g., stability, squareness, or the like) of the mobile factory 100 under a very high load may be provided by the continuous rail system 116. The continuous rail system 116 may be pulled into the mobile factory 100 (e.g., within the fabrication space 108). The rails 906 may be pinned to the floor 112 of the mobile factory 100. The rails 906 may be designed to spread the load out, for instance like a continuous beam equal to the length of the floor 112 of the mobile factory 100. The floor 112 of the modules 106 may facilitate spreading the load out further, for example by dispersing the load to the skids 110 and the ground.

The particular rails 906 mentioned here may provide for reductions in deflection in the continuous rail system 116 (and the modules 106), for example when compared to other approaches. Accordingly, the mobile factory 100 may allow the fabrication of the tower sections 700 to be much more precise and accurate, for instance when welding the components together (e.g., the sub-sections 816). The rails 906 may be included in the tower racking area 1700 or the exterior 602 of the mobile factory 100.

The modules 106 may provide the fabrication space 108, and the fabrication space 108 may facilitate one or more manufacturing operations of the mobile factory 100. For instance, a plate preparation station 1702 may facilitate one or more manufacturing operations for the tower sections 700. In an example, the plate preparation station 1702 may provide for edge preparation, welding on of ancillary connectors (e.g., for future installation of electrical brackets and ladders downstream in the factory 100), or other plate preparation operations. Accordingly, the plate preparation station 1702 may facilitate manufacturing of the sub-sections 816 of the tower sections 700. The plate preparation station 1702 may be included in the exterior 602 of the mobile factory 100, or within the fabrication space 108. In one or more embodiments, the plate preparation station 1702 may be included in the factory 100 at the beginning of the factory 100 (e.g., at the second end 104), for instance to facilitate localized steel preparation work, instead of bringing items into the factory 100 from a mill or other manufacturing facility (e.g., ready-made components, or the like).

The sub-sections 816 (shown in FIG. 8B) may be fabricated at the mobile factory 100, for instance at the plate preparation station 1702. In an example, sheets of material (e.g., steel, stainless steel, aluminum, composites, polymers, or the like) may undergo one or more manufacturing operations. For instance, the sheets of material may undergo one or more of sheering, bending, rolling, crimping, debarring, cutting, punching, tempering, or the like to provide the sub-sections 816 of the tower sections 700. In an example, the sub-sections 816 have a circular (or semicircular) profile. The sub-sections 816 having a semicircular profile may be coupled together to provide the tower section 700 with a circular profile. For instance, automatic sub-arc welding may take place on up to, but not limited to, five, 12 foot wide plate sections.

One or more manufacturing operations may be performed upon the sub-sections 816, for example with the sub-sections 816 loaded on the carts 702. Accordingly, the carts 702 may cooperate with the fabrication stations 120 during one or more manufacturing operations for the tower sections 700. In an example, the fabrication stations 120 (e.g., the welding stations 812, shown in FIGS. 8B and 8C) may provide for circumferentially, longitudinally, and/or spirally welding of the tower sections 700 (and the sub-sections 816). The welding stations 812 may provide for sub arc welding, TIG welding, MIG welding, or other weld operations and may also provide for back gouging or other ancillary welding operations.

As shown in FIG. 8B, the welding may take place in a circular motion with substantially stationary welding heads 902. The tower sections 700 (including sub-sections 816) may be rolled, and the sub-sections 816 may be welded, for example along the circumferential seam 818B. Accordingly, the sub-sections 816 may be coupled to provide the tower section 700. In one or more embodiments, half circular plate sections (e.g., the sub-sections 816), that are road transportable, may be delivered to the mobile factory 100 already prepared for one or more manufacturing operations (e.g., welding, or the like).

In an example, the sub-sections 816 may undergo one or more longitudinal welding operations. For instance, the longitudinal welding operations may be performed with the sub-sections 816 in a horizontal position. The one or more welding heads 902 may be stationary (or substantially stationary). The welding heads 902 may be positioned on either side of the sub-sections 816. In an example, the cart 702 is moved along the continuous rail system 116 during a welding operation with the welding heads 902. For instance, carts 702 may move along the rails 906, and the carts 702 may move relative to the welding heads 902. In an example, the carts 702 may be moved along the rails 906 to weld along the longitudinal seam 818A of the tower sections 700. Accordingly, the carts 702 may facilitate one or more manufacturing operations within the mobile factory (e.g., welding of the sub-sections along one or more of the seams 818).

After longitudinal welding, the tower section may be moved to the next zone 600 of the mobile factory 100, for example along the continuous rail system 116 while supported by the carts 702. The tower sections 700 (and sub-sections 816) may undergo a circumferential welding operation. The circumferential welding operation may include adding flanges at each end of the section 700, for instance to allow multiple sections to be fastened together during erection of the windmill tower. The tower section 700 may be rotated about a rotational axis (e.g., rolled around the centerline) of the round section 700. For example, rotation of the tower section 700 facilitates automatic welding with stationary welding heads 902. Thus, the welding stations 812 may not need to move spatially within the fabrication space 108 to circumferentially weld the tower sections 700 (and sub-sections 816).

The inspection station 810 may provide for evaluation of the tower sections 700. For instance, evaluation of the tower sections 700 may include non-destructive evaluation (e.g., ultrasonic testing, x-ray imaging, microscopy, metrology, or the like) or other evaluation operations. The tower sections 700 may be evaluated for quality control of the tower sections 700. In an example, the inspection station 810 may facilitate quality control of one or more of the manufacturing operations (e.g., welding operations, or the like).

In an example, the cleaning station 808 facilitates one or more cleaning operations for the tower section 700 (e.g., sand blasting, pressure washing, laser cleaning, or the like). The tower section 700 may be moved (e.g., laterally or rotationally with the carts 702) to facilitate the cleaning operations with the cleaning station 808. Thus, the cleaning station 808 may not need to move spatially. The cleaning station may be contained to one small area inside fabrication space 108 (e.g., the zone 600B) for clean up as the tower section 700 passes through the area. The cleaning station 808 may laser clean the tower section 700, which may reduce clean up of the mobile factory 100, such as clean up of sand.

The finishing station 806 may facilitate one or more corrosion control operations for the tower section 700. In an example, the finishing station 806 may be located in the zone 600A. The carts 702 may move the tower section 700 during the corrosion control operations (e.g., by rotating the tower sections 700). The finishing station 806 may be stationary, and the carts 702 may move the tower section 700 to facilitate the corrosion control operations. For instance, the finishing station 806 may facilitate a coating process (e.g., painting, or the like) for the tower sections 700. The vinyl wrapper 807 may couple a vinyl material (e.g., a sheet of vinyl, plastic, or the like) to the tower sections 700. The vinyl material (or the coating) may protect the tower sections 700 from corrosion, and may enhance the aesthetics of the tower sections 700. While painting including priming and painting may be a common approach to corrosion protection, other corrosion protection approaches such as a vinyl wrap, may reduce the need for cleanup and exhaust ventilation. Accordingly, the corrosion control operations may be contained to one small area inside this station to allow for clean up as the tower section 700 passes through this station. Further to the factory layout design, the portable factory 100 in a remote location may not need the finishing station if the tower was built with corrosion resistant material such as ASTM A588 Gr.B plate, stainless steel, aluminum, or other corrosion resistant material.

The tower racking area 1700 may provide staging for several sections 700 of the windmill tower, for instance to allow for interior components of the windmill to be completed. The interior components for the windmill may include, but are not limited to ladders, elevators, rest platforms, electrical cables and trays, or the like. The tower racking area 1700 may have an isolated drying bay (e.g., provided by the access systems 122), for instance if a coating is used as corrosion protection. The drying bay may be the first module before the rest of the tower racking area 1700 (e.g., the first zone 600 in the racking area 1700 adjacent the finishing station 806). The tower racking area 1700 may have pipe handling equipment similar to an oilfield drilling rig pipe shed to aid in the automated movement of the windmill tower components (e.g., the tower sections 700, or the like). The exit door (e.g., curtain 126, shown in FIG. 1) on the end of the tower racking area 1700 may have pipe handling arms that aid in loading the sections of tower onto multi wheeled movers for transport to the local windmill farm concrete foundations.

The tower section 700 may be transferred to waiting multi-wheeled movers, the trailer 606 (shown in FIG. 6), or the like, for transport to the local windmill farm foundations. For example, the tower section 700 may be loaded onto the trailer 606 in the docking area 604 of the mobile factory 100. The trailer 606 may transport the tower section 700 (that exceeds over-the-road restrictions) to a foundation (e.g., a concrete footing, or the like) for a windmill.

The access systems 122 (shown in FIG. 8A) may enhance isolation of the zone 600A from other portions of the mobile factory 100. For instance, the curtains 126 may be lowered to partition the fabrication space 108 and enhance isolation between the zones 600 of the mobile factory 100. The access systems 122 may facilitate isolation between the fabrication space 108 and the exterior 602 of the mobile factory 100.

The HVAC systems 128 (shown in FIG. 1) may facilitate climate control within the zones 600, for example to provide a specified atmospheric condition (e.g., temperature, humidity, dew point, or the like) within a specified zone. For instance, the HVAC systems 128 may facilitate a first atmospheric condition (e.g., 67 degrees and 55 percent humidity, or the like) in the first zone 600A, and a second atmospheric condition (e.g., 80 degrees and 10 percent humidity, or the like). Accordingly, the zones 600 of the mobile factory 100 may be climate controlled, for instance based on an intended purpose for a specific zone (e.g., the zone 600A, or the like).

Although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A mobile factory, comprising:
a plurality of over-the-road collapsible and expandable modules configured for interconnection with one another to provide a fabrication space, wherein the modules include one or more skids configured to engage with a foundation and support a floor of the fabrication space;
a first welding station included in the fabrication space;
an inspection station included in the fabrication space;
a continuous rail system coupled to the floor of the fabrication space, wherein the continuous rail system is configured to facilitate movement of components of a manufacturing operation within the fabrication space, including movement between the first welding station and the inspection station.

2. The mobile factory of claim 1, wherein:
the plurality of over-the-road collapsible and expandable modules includes a first module having a first floor section and a second module having a second floor section; and
the continuous rail system is configured to couple with the first floor section and the second floor section.

3. The mobile factory of claim 1, wherein:
the plurality of over-the-road collapsible and expandable modules includes a first module and a second module;
the continuous rail system includes a first rail segment included in the first module and a second rail segment included in the second module; and
the first rail segment is configured to align with the second rail segment when the first module is interconnected with the second module.

4. The mobile factory of claim 1, wherein:
the first welding station is included in a first location along the continuous rail system;
the inspection station is included in a second location along the continuous rail system;
and the continuous rail system facilitates movement of the components between the first welding station and the inspection station.

5. The mobile factory of claim 1, wherein the skids, the floor, and the continuous rail system cooperate to provide a level manufacturing surface within the fabrication space.

6. The mobile factory of claim 5, wherein:
the plurality of over-the-road collapsible and expandable modules includes a first module and a second module;
the first module has a first floor section moveable relative to a first skid;
the second module has a second floor section moveable relative to a second skid; and
the movement of the first floor section relative to the first skid and the second floor section relative to the second skid cooperate to provide a level floor within the fabrication space.

7. The mobile factory of claim 5, wherein:
the continuous rail system includes a first rail section having a first adjustment mechanism configured to translate the first rail section relative to the floor of the fabrication space;
the continuous rail system includes a second rail section having a second adjustment mechanism configured to move the second rail section relative to the floor of the fabrication space;
the first adjustment mechanism and the second adjustment mechanism cooperate to provide the level manufacturing surface within the fabrication space.

8. The mobile factory of claim 1, further comprising a tensioning system configured to compress the modules together to facilitate the interconnection of the modules with one another.

9. The mobile factory of claim 1, further comprising a transportation system configured to move the components and facilitate movement of the components along the continuous rail system.

10. The mobile factory of claim 1, further comprising a transportation system including an overhead component handling system coupled along a roof of the fabrication space, wherein the overhead component handling is configured to move the components for the manufacturing operation and facilitate one or more of vertical movement or lateral movement of the components within the fabrication space.

11. The mobile factory of claim 10, wherein:
the plurality of over-the-road collapsible and expandable modules includes a first module having a first roof;
a portion of the transportation system is coupled to the first roof of the first module; and
in a collapsed configuration, the first module is configured to shield the portion of the portion of the transportation system that is coupled to the first roof.

12. The mobile factory of claim 1, further comprising a cart configured for moveable coupling along the continuous rail system, wherein the cart is configured to support the components of the manufacturing operation and to facilitate movement of the components within the fabrication space.

13. The mobile factory of claim 12, wherein the cart includes one or more actuators configured to engage with the components and articulate the components to change a position of the components supported by the cart.

14. The mobile factory of claim 13, wherein the one or more actuators are configured to rotate the components of the manufacturing operation.

15. The mobile factory of claim 13, wherein the one or more actuators are configured to laterally displace the components of the manufacturing operation.

16. The mobile factory of claim 13, wherein:
the components of the manufacturing operation include a first component and a second component;
the first welding station includes a stationary welding head configured to weld the first component and the second component together; and
the articulation of the components by the one or more actuators facilitate welding along a seam of the first component and the second component with the stationary welding head.

17. The mobile factory of claim 1, wherein:
the components of the manufacturing operation include a first component and a second component;
the first component is a first section of a tower for a windmill;
the second component is a second section of the tower; and
the first welding station includes a welding head configured to weld the first component and the second component together to provide a welded assembly.

18. The mobile factory of claim 17, wherein the welded assembly defines a diameter that exceeds over-the-road width restrictions.

19. The mobile factory of claim 1, further comprising:
a cart configured for moveable coupling along the continuous rail system, wherein the cart is configured to support the components of the manufacturing operation; and
a transportation system including a cart transport system configured to move the cart and to facilitate lateral movement of the cart along the continuous rail system.

20. A mobile factory, comprising:
a plurality of collapsible and expandable modules configured for interconnection with one another to provide a fabrication space with a first end and a second end;
a continuous rail system configured for extending through the plurality of modules to control relative movement of the modules and guide components through the fabrication space; and
a tension tie system configured for securing to the plurality of modules at the first end and the second end of the fabrication space and configured to compress the plurality of modules together.

21. The mobile factory of claim 20, wherein the modules include one or more skids configured to rest on the ground and establish a floor of the fabrication space.

22. The mobile factory of claim 21, wherein the modules include a pair of bi-fold walls pivotally secured to the skid and extending upward from the skid at opposing ends of the skid.

23. The mobile factory of claim 22, wherein the bi-fold walls are adapted to collapse vertically and have a horizontally extending hinge at a mid-height thereof.

24. The mobile factory of claim 23, wherein the bi-fold walls have an expanded height approximately equal to a length of the skid.

25. The mobile factory of claim 24, wherein the modules include a roof extending between the pair of bi-fold walls.
